(19) United States
(12) Patent Application Publication
(10) Pub. No.: US 2012/0037620 A1
(43) Pub. Date: Feb. 16, 2012

(54) SEPARABLE CONTENTS PLATE, AND METHOD FOR MOLDING COSMETICS USING SAME

(76) Inventors: Yoonsung Park, Gyeonggi-do (KR); Keonchang Lee, Incheon (KR)

(21) Appl. No.: 13/265,940

(22) PCT Filed: May 20, 2009
(86) PCT No.: PCT/KR2009/002665

§ 371 Date: Oct. 24, 2011

(30) Foreign Application Priority Data
Apr. 27, 2009 (KR) 10-2009-0036808

(51) Int. Cl. B65D 6/28; B29C 39/12

(52) U.S. Cl. 220/4.01; 264/39

(57) ABSTRACT

A separable contents plate, and a method for molding cosmetics using same which makes a pattern stand out on the surface of a multi-colored solid foundation product, wherein a separable contents plate composed of a wall body and a bottom body is provided. The method comprises the steps of: injecting 1st liquid content between the inner side surface of the wall body and the outer side surface of a core, and solidifying the 1st liquid content after the core which matches with the wall body and the pattern is settled at a silicone plate having a pattern formed at an inner bottom surface; and injecting 2nd content having a color different from that of the 1st content into the separated part after separating the core from the silicone plate to fill the pattern with the 2nd content, and solidifying the 2nd content. As a result, a pattern is formed on the surface when content having different colors are put in the separable plate to be molded, and the pattern is formed through engraving or embossing on the surface of a product according to color, thereby distinguishing a product from other products and suiting the consumer's taste for increasing product sales.

### BACKGROUND OF THE INVENTION

The present invention relates to a separable contents plate and a method for molding cosmetics using the same, and more particularly, to a separable contents plate which contains a multi-colored skin cover product in such a fashion that a pattern with different colors is formed on the surface of the cosmetic product by colors through engraving or embossing on the surface of the cosmetic product, and a method for molding cosmetics by embossing a pattern on the surface of the multi-colored solid foundation product using the separable contents plate.

In general, in order to put on makeup, users use various kinds of cosmetics with various functions and forms according to their tastes or characteristics of skin. The most common cosmetic products are makeup base, skin powder, twoway cake, powder pact, skin cover, and so on.

Most of such cosmetic products are manufactured through the steps of dosing oily powder formulas into a plate and pressing and molding them by a press to be compressed into solidified cosmetic products.

Particularly, such cosmetic products consist of substrates, such as talc, titanium dioxide, mica, silica, nylon powder, Polymethyl Methacrylate, sericite, kaolin, bismuth oxychloride, and so on, pigments for coloring the substrates, and a binder for combining the ingredients. For the binder, silicon-base oil, hydrocarbon-based oil, high class fatty acid-based oil, high class alcohol-based oil, ester-based oil, glyceride-based oil, lanolin-based oil, animal fat-based oil, plant-based oil, and so on are selectively used.

Cake foundation products containing the above ingredients present more exclusive and beautiful images not by monotonous surfaces but by various patterns or designs formed on the surfaces of the cosmetic products. In this instance, the patterns or designs formed on the surfaces of the cosmetic products are generally made by one of three methods: one being a method of emphasizing exclusivity by carving wanted patterns on the surface of face powder using laser; another being a method of maximizing a pearl effect by minutely spraying pearl on the surface of the cosmetic products using the powder-spray technique; and the other one being a method of forming a laser marking after pearl printing.

However, the method of carving patterns using laser has a problem in that the exclusivity or high-class ornament effect by the patterns are not be continued because the patterns formed on the surface of powder are easily obliterated when the user rubs the product with a puff several times in order to use the product. Moreover, the method of coating pearl on the surface of powder through the powder-spray technique also has the same problem as the former method because pearl is sprayed only the surface of the product.

Furthermore, the method of forming laser marking after pearl printing also has a problem in that the patterns formed on the surface of powder are obliterated when the user uses the product several times because the patterns or shapes are formed only the surface of the product through line marking.

Accordingly, the methods of forming patterns on the surface of the products have several problems in that they decrease productivity due to excessive working processes and in that the products manufactured through the above-mentioned methods have a short lifespan because the patterns formed on the surface of powder are easily obliterated, and hence, the products manufactured through the above-mentioned methods cannot create higher profits.

### SUMMARY OF THE INVENTION

Accordingly, the present invention has been made in an effort to solve the above-mentioned problems occurring in the prior arts, and it is an object of the present invention to provide a separable contents plate which contains a multi-colored solid foundation product in such a fashion that a pattern with different colors is formed on the surface of the cosmetic product by colors through engraving or embossing on the surface of the cosmetic product, and a method for molding cosmetics by embossing a pattern on the surface of the multi-colored solid foundation product using the separable contents plate.

Another object of the present invention is to provide a separable contents plate, which allows rapid mass-production of cosmetic products and reduces an error rate of products to thereby maximize productivity, and a method for molding cosmetics by embossing a pattern on the surface of the multi-colored solid foundation product using the separable contents plate.

To achieve the above objects, the present invention provides a separable contents plate including: a bottom body (12) on which solid foundation is put; and a ring-shaped wall body (14) formed along the outer circumference of the bottom body (12), wherein the bottom body (12) getting in contact with the solid foundation has a tread pattern (12c) formed on the inner surface thereof.

Moreover, the present invention provides a separable contents plate including: a bottom body (12) on which solid foundation is put; and a ring-shaped wall body (14) formed along the outer circumference of the bottom body (12), wherein the bottom body (12) has a spiral thread (12b) formed on the side surface thereof and the wall body (14) has a spiral thread (14b) formed on the inner surface of the lower end thereof, so that the wall body (14) and the bottom body (12) are screw-coupled with each other.

Furthermore, the present invention provides a separable contents plate including: a bottom body (12) on which solid foundation is put; and a ring-shaped wall body (14) formed along the outer circumference of the bottom body (12), wherein the wall body (14) has a joining hole (14d) downwardly opened and bent from the inner surface of the lower end thereof and the bottom body (12) has a joining protrusion (12d) formed on the side surface thereof and inserted and joined to the joining hole (14d).

In another aspect of the present invention, the present invention provides a method for molding cosmetics using a separable contents plate (10) that is manufactured by joining a bottom body (12), on which solid foundation is put, and a ring-shaped wall body (14), which is formed along the outer circumference of the bottom body (12), with each other, including: a mold preparing step (S100) of seating the wall body (14) on the upper face of a silicon plate (20), which has a pattern graved in relief on an inner bottom surface (22) thereof, and seating a core (30), which has a pattern formed on the bottom surface in correspondence to the pattern of the inner bottom surface (22) of the silicon plate (20), on the silicon plate (20); a first filling step (S200) of injecting a liquid content to the silicon plate (20), solidifying the injected content, and separating the core (30) from the silicon plate (20); a second filling step (S300) of injecting another liquid content, which has a color different from that of the first filling step (S200), to a portion where the core (30) is separated from the silicon plate (20) after the core (30) is separated from the silicon plate (20) in the first filling step (S200); and a contents plate separating step (S400) of forming the separable contents plate (10) by joining the bottom body (12) to the wall body (14) when the content injected in the second filling step (S300) is solidified, and separating the separable contents plate (10) and the solidified content from the silicon plate (20).

Additionally, it is preferable that the mold preparing step (S100) includes: a loading step (S110) of fixing the silicon plate (20) having the pattern, which is carved in relief on the inner bottom surface (22), at a conveyance jig (40) and loading the conveyance jig (40) on the transfer conveyer (100); a wall body seating step (S120) of seating the wall body (14) on the silicon plate (20) loaded on the transfer conveyer (100); and a core seating step (S130) of seating the core (30), which has the pattern formed on the bottom surface thereof in correspondence to the pattern of the inner bottom surface (22) of the silicon plate (20), on the silicon plate (20).

In addition, the first filling step (S200) includes: a filling step (S210) of injecting a first liquid content (S1) to the silicon plate (20); a first cooling step (S220) of solidifying the first content (S1) filling the silicon plate (20); and a core separating step (S230) of separating the core (30) from the first content (S1) solidified after the first cooling step (S220).

Moreover, it is preferable that the core (30) separated from the silicon plate (20) in the core separating step (S230) is returned to the mold preparing step (S100).

Furthermore, it is preferable that the second filling step (S300) includes: a filling step (S310) of injecting a second liquid content (S2), which has a color different from that of the first content (S1), to a portion where the core (30) is separated from the silicon plate (20); and a second cooling step (S320) of solidifying the second content (S2) filling the silicon plate (20).

Additionally, it is preferable that the contents plate separating step (S400) includes: an arranging step (S410) of locating the bottom body (12) above the wall body (14) seated on the silicon plate (20); an assembling step (S420) of joining the bottom body (12) to the wall body (14); and a separating step (S430) of separating the separable contents plate (10) formed in the assembling step (S420) from the silicon plate (20).

In addition, in the separating step (S430), when the separable contents plate (10) is formed by the joining of the bottom body (12) and the wall body (14), a load (770) upwardly pushes the bottom surface of the silicon plate (20), so that there occurs a gap between the inner bottom surface (22) of the silicon plate (20) and the solidified first and second contents (S1, S2).

As described above, according to the present invention, the separable contents plate and the method for molding cosmetics by embossing a pattern on the surface of the multi-colored solid foundation product using the separable contents plate are differentiated among other cosmetic products and can adapt to consumers' tastes to thereby increase a sales volume of the cosmetic product because a pattern is formed on the surface of the solid foundation product and the pattern is engraved or embossed from the surface of the cosmetic product by colors when the cosmetic contents with different colors are respectively put in the contents plate.

Moreover, the present invention can increase productivity and reduce an error rate of products to thereby reduce a manufacturing price of products because it allows a rapid mass-production when the cosmetic product with a multi-colored pattern is molded in such a fashion that a single-color cosmetic content is engraved or embossed on the surface of the product in the form of the pattern by colors.

### BRIEF DESCRIPTION OF DRAWINGS

FIG. 1 is a perspective view of a separable contents plate according to a preferred embodiment of the present invention.

FIG. 2 is an exploded perspective view of the separable contents plate.

FIG. 3 is a sectional view of the separable contents plate.

FIG. 4 is a perspective view of a separable contents plate according to another preferred embodiment of the present invention.

FIG. 5 is a sectional view of the separable contents plate of FIG. 4.

FIG. 6 is a sectional view of a separable contents plate according to a further preferred embodiment of the present invention.

FIG. 7 is a flow chart of a method of molding cosmetics using the separable contents plate according to the present invention.

FIGS. 8 and 9 are a perspective view and a plan view showing an example of a cosmetics molding system for engraving or embossing a pattern on the surface of a multi-colored solid foundation product using the separable contents plate according to the present invention.

FIGS. 10 and 11 are a perspective view and a side sectional view of a first injector for injecting a liquid content to a silicon plate in a mold preparing step and a first filling step according to the present invention.

FIGS. 12 to 15 are a perspective view and a side sectional view showing a first cooling device for solidifying the first content injected to the silicon plate in the first filing step and a core separator for separating a core from the silicon plate, where the first content is solidified, and operational states of the first cooling device and the core separator.

FIGS. 16 and 17 are a perspective view and a side sectional view showing a second injector for injecting a second liquid content to a portion where the core is separated from the silicon plate after the first filling step.

FIGS. 18 to 20 are side sectional views showing a process of forming the separable contents plate by joining a bottom body to a wall body, which is seated on the upper surface of the silicon plate and separating the contents plate from the silicon plate after the second filling step.

FIG. 21 is a partially sectional perspective view showing a multi-colored solid foundation product contained in the separable contents plate manufactured through the cosmetics molding method using the separable contents plate.

### EXPLANATION OF ESSENTIAL REFERENCE NUMERALS IN DRAWINGS

| | |
|---|---|
| 10: separable contents plate | 12: bottom body |
| 14: wall body | 20: silicon plate |
| 30: core | 40: conveyance jig |
| 100: transfer conveyer | 200: first injector |
| 300: first cooling device | 400: core separator |
| 410: elevation unit | 420: receiving unit |
| 422: electromagnet | 430: return conveyer |
| 500: second injector | 600: second cooling device |
| 700: extractor | 710: absorbing plate |
| 720: conveying unit | 730: air-inhaling unit |
| S1: first content | S2: second content |

### DETAILED DESCRIPTION OF THE INVENTION

Reference will be now made in detail to the preferred embodiment of the present invention with reference to the attached drawings.

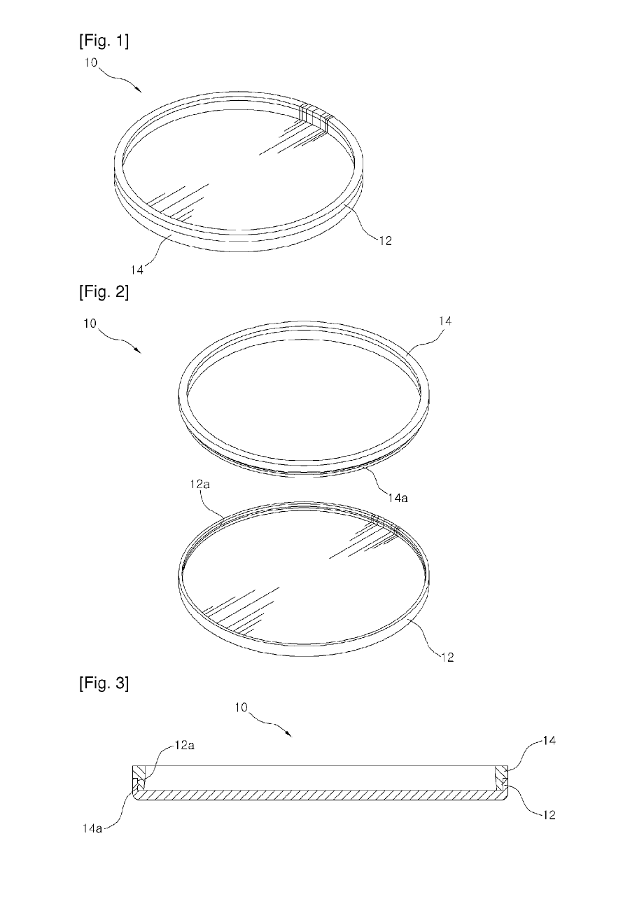

FIG. 1 is a perspective view of a separable contents plate according to a preferred embodiment of the present invention, FIG. 2 is an exploded perspective view of the separable contents plate, and FIG. 3 is a sectional view of the separable contents plate.

Referring to the drawings, the separable contents plate according to the present invention includes a bottom body 12 on which solid foundation is put, and a ring-shaped wall body 14 formed along the outer circumference of the bottom body 12.

A form of the bottom body 12 corresponds to a cosmetic container (not shown), in which the separable contents plate 10 is contained. The bottom body 12 is generally a plate of a round or rectangular shape and has a projection 12a with a predetermined height formed along the outer circumference thereof.

The ring-shaped wall body 14 is assembled through a concavo-convex joint with the projection 12a of the bottom body 12, so that the separable contents plate 10 which can contain a skin cover product or a solid foundation product therein is made.

That is, the projection 12a formed along the outer circumference of the bottom body 12 is concavo-convex coupled with a stepped jaw 14a formed on a lower end of the wall body 14, so that the separable contents plate 10 is formed, and then, liquid content, which will become solid foundation, is contained in the contents plate 10.

When the liquid content is injected on the upper surface of the bottom body 12 of the separable contents plate 10, which is formed by assembling the bottom body 12 and the wall body 14, the liquid content is naturally solidified as time goes by or forcedly solidified while passing a cooling device.

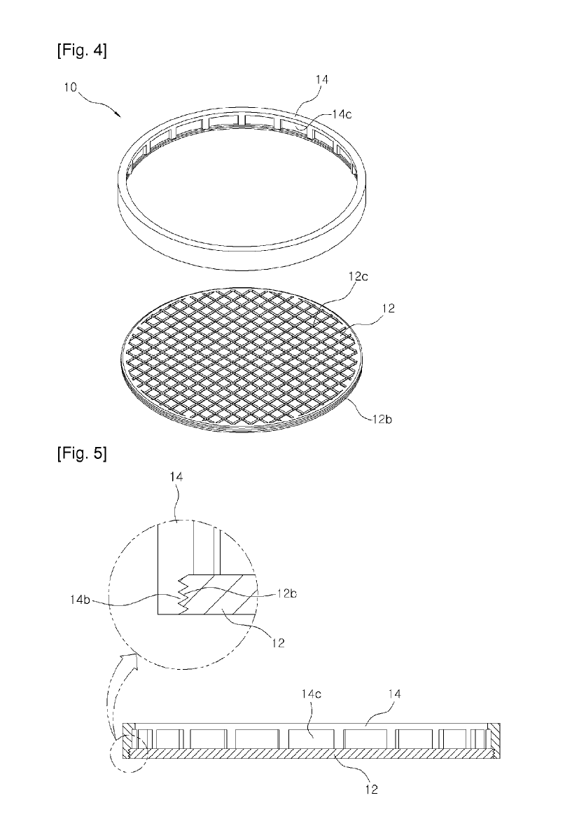

Moreover, the above-mentioned structure of the separable contents plate can prevent that the solid foundation is randomly separated from the separable contents plate 10 when the solid foundation is seated in the contents plate 10, and make the joint of the wall body 14 and the bottom body 12 stronger. The structure will be now described referring to FIGS. 4 to 6.

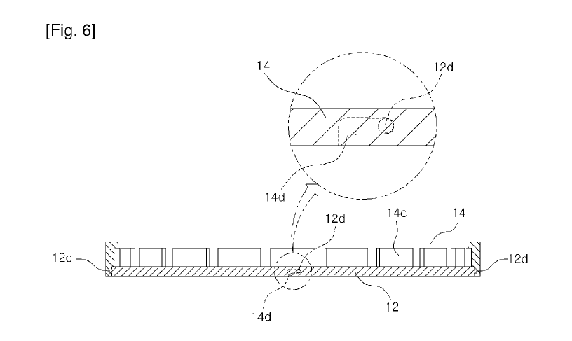

FIG. 4 is a perspective view of a separable contents plate according to another preferred embodiment of the present invention, FIG. 5 is a sectional view of the separable contents plate of FIG. 4, and FIG. 6 is a sectional view of a separable contents plate according to a further preferred embodiment of the present invention.

Referring to the drawings, the bottom body 12 in which the solid foundation is seated has a tread pattern 12c formed on the inner face thereof and the wall body 14 has receiving indentations 14c formed on the inner face thereof in order to increase a contact area between the solid foundation and the separable contents plate 10 and to increase the surface roughness of faces that the solid foundation and the separable contents plate 10 meet each other to thereby prevent the solid foundation from being separated from the separable contents plate at random.

That is, the tread pattern 12c formed on the inner face surface of the bottom body 12 and the receiving indentations 14c formed on the inner face of the wall body 14 respectively have grooves of the same pattern rule as tread patterns formed on tires of vehicles, such as cars, and hence, the liquid content flows into the grooves and is solidified therein when the liquid content, which will become the solid foundation, is put in the separable contents plate 10, so that the contact area is increased and it can prevent the separation of the solid foundation from the separable contents plate 10.

The tread pattern 12c and the receiving indentations 14c may have the grooves formed at regular intervals as shown in the drawings, but according to occasions, may be concavo-convex patterns repeatedly formed on the inner face of the bottom body 12 and the inner face of the wall body 14 and spaced apart from one another at predetermined intervals.

Furthermore, in order to make the joining between the bottom body 12 and the wall body 14 stronger when the bottom body 12 and the wall body 14 are joined with each other, the wall body 14 has a spiral thread 14b formed on the inner face of the lower end thereof and the bottom body 12 has a spiral thread 12b formed on the side surface thereof, so that the bottom body 12 and the wall body 14 can be screw-coupled with each other. Alternatively, the wall body 14 may have a joining hole 14d downwardly opened and bent, which is formed in the inner face of the lower end of the wall body 14, and the bottom body 12 may have a joining protrusion 12d formed on the side surface thereof, so that the bottom body 12 and the wall body 14 can be joined with each other when the joining protrusion 12d is inserted into the joining hole 14d.

As described above, because the bottom body 12 and the wall body 14 have the spiral threads 12b and 14b or the joining protrusion 12d and the joining hole 14d, when the bottom body 12 is joined to the wall body 14 in such a fashion that the bottom body 12 is assembled to the wall body 14 by rotation of the bottom body 12, the joining of the bottom body 12 and the wall body 14 can become stronger.

In the present invention, the bottom body 12 and the wall body 14 formed separately are assembled with each other without being formed integrally, and the reason is to provide the cosmetic product, such as skin cover or solid foundation, contained in the contents plate 10 with various colors and to make the cosmetic content with one out of the various colors have a pattern formed through engraving or embossing from the surface of the product.

That is, as shown in FIG. 21, a first content S1 and a second content S2, which have different colors, are contained in the separable contents plate 10 made by assembling the bottom body 12 and the wall body 14, and one of the first and second contents S1 and S2 has a pattern formed on the surface that consumers can see visually as shown in the drawing, in such a fashion that the pattern is engraved or embossed from the surface.

As described above, the cosmetic product with various colors and the pattern engraved or embossed from the surface can be discriminated from other cosmetic products and meet the consumers' tastes to thereby increase the sales volume of the products.

Additionally, in the solid foundation contained in the separable contents plate 10 according to the present invention, the first content S1 with a single color is put in the contents plate 10, and then the second content S2 with a color different from that of the first content S1 is put in the contents plate 10, and in this instance, the second content S2 is not mixed with the first contents S1 in color and forms a pattern having only the color of the second content S2.

Particularly, the surface of the second content S2 protrudes or is sunken more than that of the first content S1, so that the consumers can separately use the first content S1 and the second content S2 or use the first content S1 and the second content S2 by mixture. In addition, because the second content S2 has the pattern engraved or embossed from the first content S1, cosmetic products using the separable contents plate 10 according to the present invention can be aesthetically discriminated from other cosmetic products to thereby increase the sales volume.

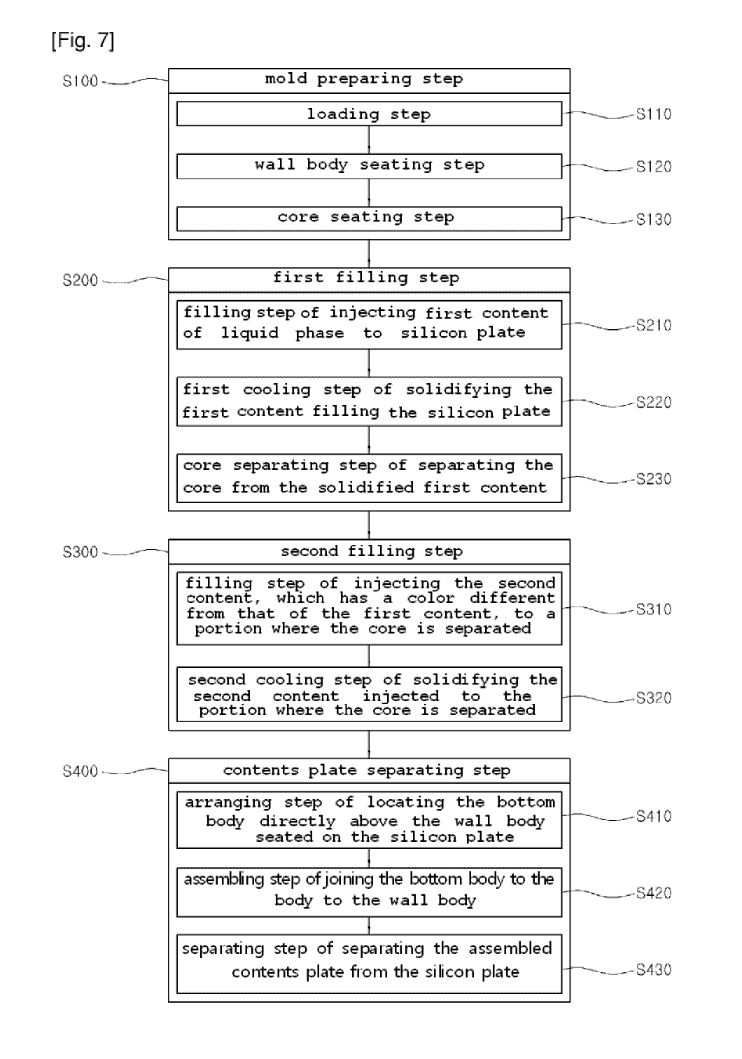

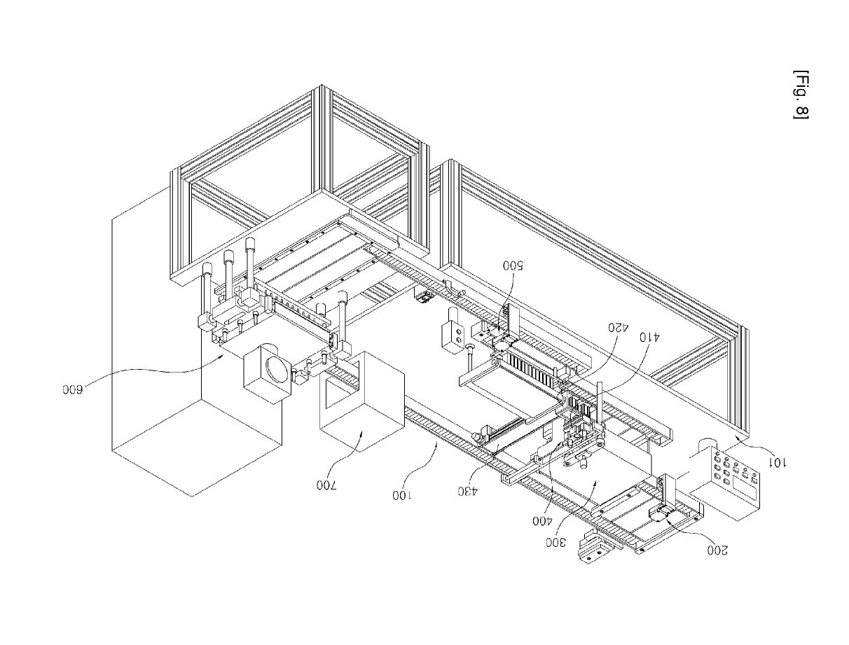

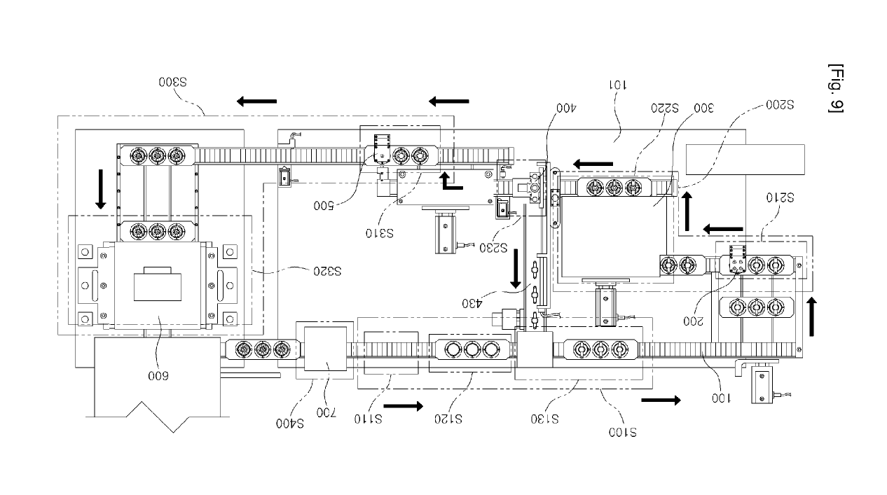

In other words, in order to mold the cosmetic product having the pattern engraved or embossed on the surface of the multi-colored solid foundation using the separable contents plate 10 that is made by joining the wall body 14 and the bottom body 12 with each other, as shown in FIG. 7, first, a mold preparing step S100 of seating the wall body 14 on the upper face of a silicon plate 20, which has a pattern graved in relief on an inner bottom surface 22 thereof, and seating a core 30, which has a pattern formed on the bottom surface in correspondence to the pattern of the inner bottom surface 22 of the silicon plate 20, on the silicon plate 20 is carried out.

When the mold preparing step S100 is finished, a first filling step S200 of injecting the liquid content S1 to the silicon plate 20, solidifying the injected content S1, and separating the core 30 from the silicon plate 20 is carried out.

When the first filling step S200 is finished, a second filling step S300 of injecting the liquid content S2, which has a color different from that of the first filling step S200, to a portion where the core 30 is separated from the silicon plate 20 is carried out. After that, when the second content S2 is solidified, a contents plate separating step S400 of forming the separable contents plate 10 by joining the bottom body 12 to the wall body 14 and separating the separable contents plate 10 from the silicon plate 20 is carried out. Through the above steps S100 to S400, cosmetic products can be molded.

That is, the wall body 14 with a predetermined height is seated on the upper face of the silicon plate 20 having the pattern graved on the inner bottom surface 22 thereof, and then, the first content S1, which becomes the basic color of the cosmetic product, is injected to the silicon plate 20.

In this instance, in order to prevent that the first content S1 flows to the pattern formed on the inner bottom surface 22 of the silicon plate 20 and fills the pattern, in a state where the core 30, which has the bottom surface having the pattern corresponding to the pattern of the inner bottom surface 22 of the silicon plate 20, is seated on the silicon plate 20, the first content S1 is injected to the silicon plate 20.

Moreover, when the first content S1 is solidified, after the core 30 is separated from the silicon plate 20, the second content S2 with the color different from that of the first content S1 is injected to the silicon plate 20 and is solidified, and then, the separable contents plate 10 is formed by joining the bottom body 12 to the wall body 14. After that, the separable contents plate 10 is separated from the silicon plate 20, and then, the cosmetic product having the pattern engraved or embossed (hereinafter, called ‘relief’) on the surface of the solid foundation can be manufactured.

In order to mold cosmetics having the pattern carved in relief on the surface of the multi-colored solid foundation through the above steps, a molding system that carries out the optimum operations by each step will be described hereinafter.

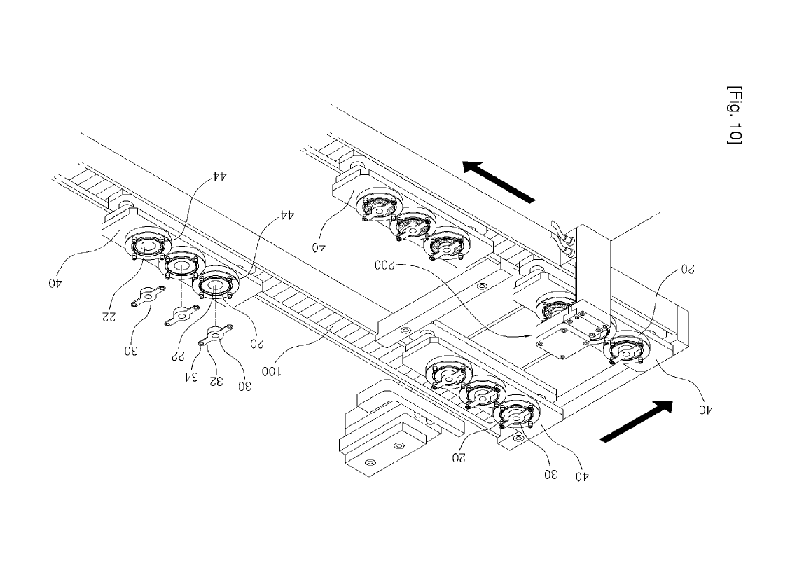

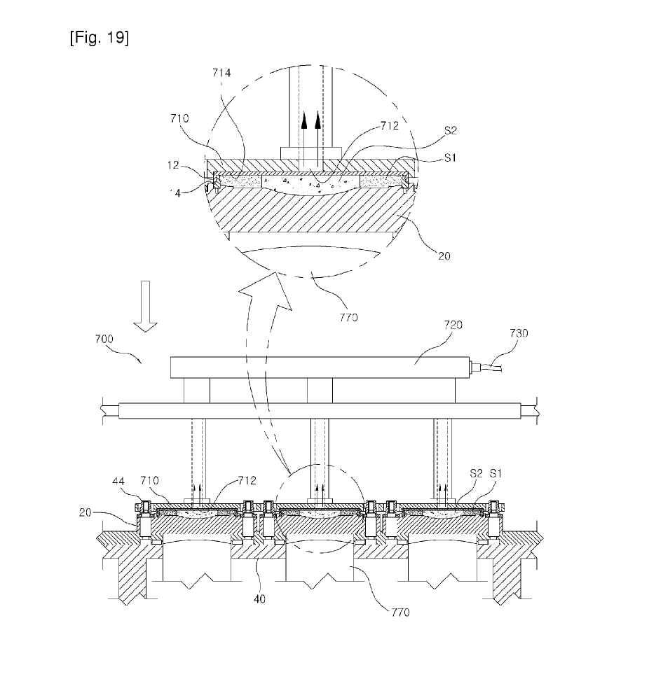

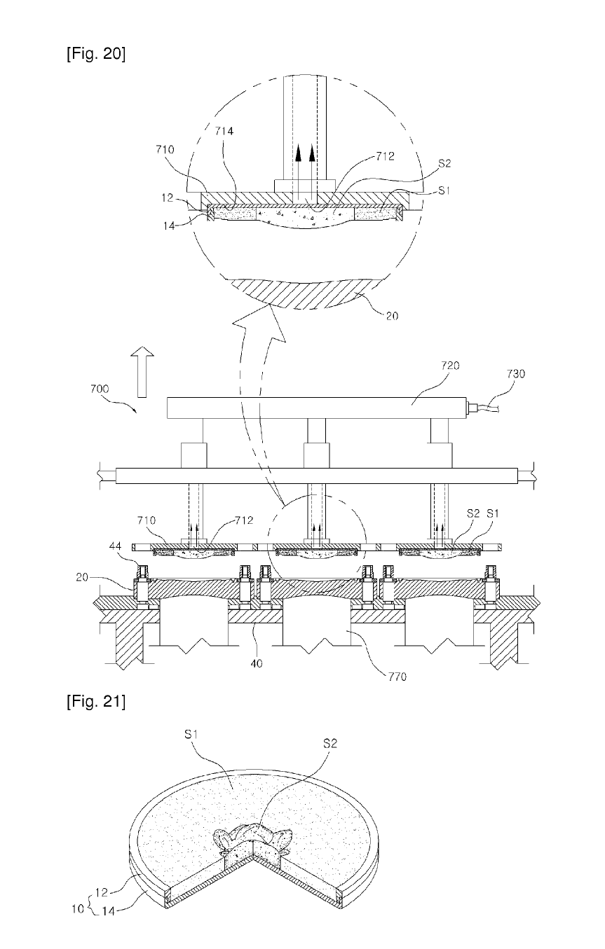

FIGS. 8 to 20 are exemplary views for explaining operations of the molding system by the steps to carve the pattern in relief on the surface of the multi-colored solid foundation using the separable contents plate 10 that is made by joining the bottom body 12 and the ring-shaped wall body 14 disposed along the outer circumference of the bottom body 12 with each other.

FIGS. 8 and 9 are a perspective view and a plan view showing an example of a cosmetics molding system for engraving or embossing a pattern on the surface of a multi-colored solid foundation product using the separable contents plate according to the present invention.

In order to mold a cosmetic product having the pattern carved in relief on the surface of the multi-colored solid foundation using the separable contents plate 10, the silicon plate 20 having the pattern carved on the inner bottom surface 22 thereof is seated on a transfer conveyer 100, and then, passes molding sections of the molding system in order.

The molding system includes: a transfer conveyer 100 for loading and conveying the silicon plate 20; a first injector 200 mounted on the transfer conveyer 100 for injecting the first content S1 of a liquid phase to the silicon plate 12; a first cooling device 300 for rapidly solidifying the first content S1 injected to the silicon plate 20; a core separator 400 for separating the core 30 from the first content S1 solidified on the silicon plate 20; a second injector 500 for injecting the second content S2 to a portion where the core 30 is separated; a second cooling device 600 for rapidly solidifying the second content S2; and an extractor 700 for extracting the separable contents plate 10, which is made by joining the bottom body 12 to the wall body 14 with each other and is seated on the silicon plate 20, and the solid foundation solidified in the separable contents plate 10.

In the molding system, the mold preparing step S100 includes the steps of: a loading step S110 of fixing the silicon plate 20 having the pattern, which is carved in relief on the inner bottom surface 22, at a conveyance jig 40 and loading the conveyance jig 40 on the transfer conveyer 100; a wall body seating step S120 of seating the wall body 14 on the silicon plate 20 loaded on the transfer conveyer 100; and a core seating step S130 of seating the core 30, which has the pattern formed on the bottom surface thereof in correspondence to the pattern of the inner bottom surface 22 of the silicon plate 20, on the silicon plate 20.

Additionally, the transfer conveyer 100, the first injector 200, the first cooling device 300, the core separator 400, the second injector 500, the second cooling device 600, and the extractor 700 are supported and mounted on a worktable 101 of a predetermined shape. In this instance, the conveyance jig 40 on which the silicon plate 20 is seated is loaded on the transfer conveyer 100. The silicon plate 20 seated on the conveyance jig 40 loaded on the transfer conveyer 100 passes the first injector 200, the first cooling device 300, the core separator 400 for separating the core 30 seated on the silicon plate 20 from the silicon plate 20, the second injector 500, and the second cooling device 600, and then, the separable contents plate 10 is made by joining the wall body 14 and the bottom body 12 with each other on the silicon plate. After that, the separable contents plate 10 is conveyed to the extractor 700.

The arrangement of the transfer conveyer 100 is optimized according to environments and structures of workplaces. That is, the first injector 200, the first cooling device 300, the core separator 400, the second injector 500, the second cooling device 600, and the extractor 700 are arranged on the transfer conveyer 100 in the optimal condition or the transfer conveyer 100 is arranged in the optimal condition in a state where the above-mentioned devices are previously arranged. In the above state, the silicon plate 20 is loaded and conveyed on the transfer conveyer 100 and passes the processes of each step in order to thereby mold a cosmetic product with a pattern graved in relief on the surface of the multi-colored solid foundation on the separable contents plate.

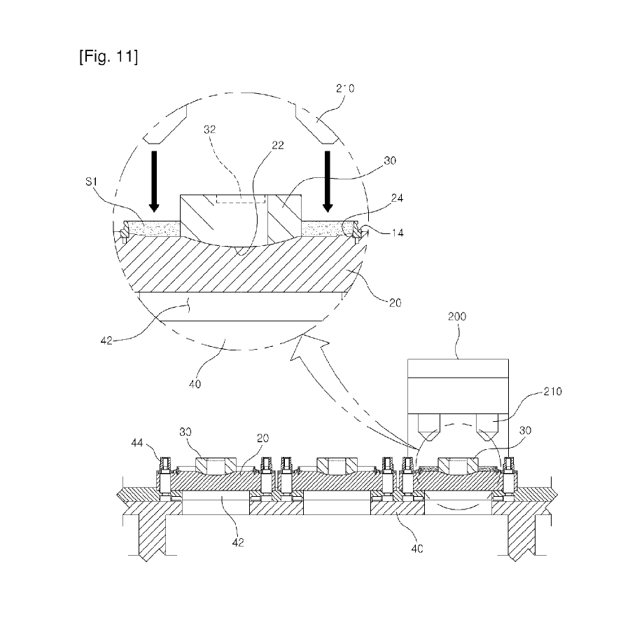

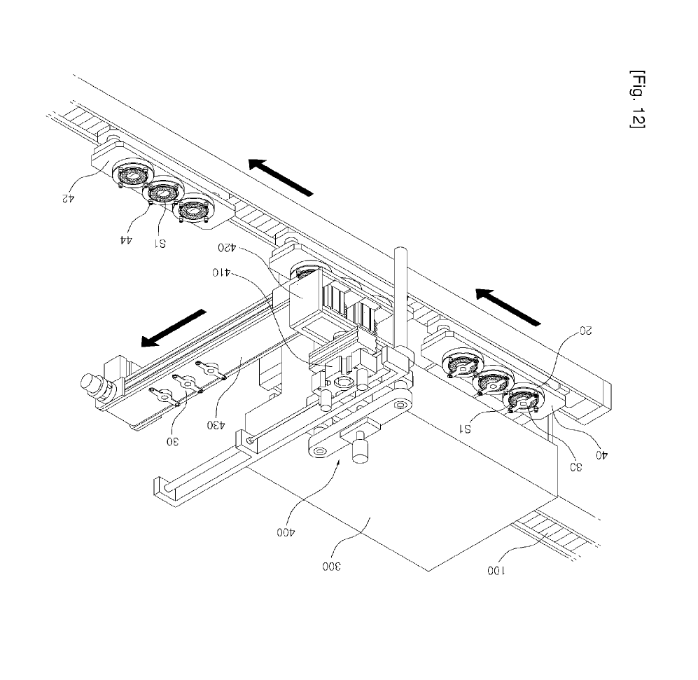

Now, referring to FIGS. 10 and 11, the first injector 200 for injecting the first liquid content S1 to the silicon plate 20, which is used in the mold preparing step S100, the first filling step S200, will be described.

Referring to the drawings, in the mold preparing step S100, when the silicon plate 20 having the pattern formed on the inner bottom surface 22 is set on the conveyance jig 40 and loaded on the transfer conveyer 100, a worker seats the wall body 14 of the separable contents plate 10 on the silicon plate 20, and in this instance, the silicon plate 20 has a pattern formed on the inner bottom surface 22 thereof and a fixing recess 24 that is formed on the circumference thereof for fixing the wall body 14 not to move and is made of a soft material.

The silicon plate 20 having the above shape and structure is set on the conveyance jig 40 of a substantially rectangular shape not to be moved. The conveyance jig 40 on which the silicon plate 20 is fixed has a through hole 42 formed at a portion of the conveyance jig, which is located directly beneath the silicon plate 20, and hence, a load 770 of the extractor 700, which will be described later, upwardly pushes the bottom surface of the silicon plate 20 in a state where the load 770 is inserted into the through hole 42, so that the separable contents plate 10 can be easily separated from the silicon plate 20.

As described above, the silicon plate 20 set on the conveyance jig 40 is conveyed by the transfer conveyer 100, and while being conveyed, the wall body 14 of the separable contents plate 10 is inserted into the fixing recess 24 of the silicon plate 20 by the worker. However, it is not restricted to that the wall body 14 of the separable contents plate 10 is seated on the upper surface of the silicon plate 20 only by the worker, and can be seated on the silicon plate 20 by various methods.

For instance, when the wall body 14 of the separable contents plate 10 is seated on the upper surface of the silicon plate 20, the wall body 14 may be supplied from an additional feeder (not shown) and conveyed by a conveying robot (not shown) having a gripper (not shown) for automatically conveying the wall body 14 from the feeder to the upper surface of the silicon plate 20 in a state where the gripper grasps a portion of the upper end of the supplied wall body 14, and such a modified example also belongs to the technical scope and idea of the present invention.

As described above, when the wall body 14 of the separable contents plate 10 is seated on the upper surface of the silicon plate 20, the core seating step S130 of seating the core 30 in the silicon plate 20 is carried out. The core 30 has the pattern formed on the bottom surface thereof in correspondence to the pattern formed on the inner bottom surface 22 of the silicon plate 20, and includes wings 32 that extend from both sides of the upper surface thereof and are detachably supported by the conveyance jig 40.

In other words, the core 30 includes pin holes 34 respectively formed at end portions of the wings 32 extending from both sides of the upper surface thereof, and the pin holes 34 are fit on pins 44 protruding from the conveyance jig 40, so that the core 30 is not moved when the core 30 is moved by the transfer conveyer 100 or when the first content S1 is injected to the silicon plate 20 by the first injector 200, which will be described later.

The step S130 of seating the core 30 in the silicon plate 20 may be carried out by the worker as described above, but according to occasions, may be carried out by the conveying robot (not shown) having the gripper (not shown) for automatically gripping the core 30.

As described above, when the mold preparing step S100, which includes: the step S110 of setting the silicon plate 20 on the conveyance jig 40 and loading the silicon plate 20 on the transfer conveyer 100; the wall body seating step S120 of seating the wall body 14 of the separable contents plate 10 on the silicon plate 20; and the core seating step S130 of seating the core 30 on the silicon plate 20, is finished, the silicon plate 20, on which the core 30 is seated, is conveyed to the first filling step S200 by the transfer conveyer 100.

The silicon plate 20 passing the mold preparing step S100 is located under the first injector 200 for injecting the first liquid content S1 to the silicon plate 20. As shown in FIG. 8, the first injector 200 has a pair of injection nozzles 210 disposed directly above the silicon plate 20, and the injection nozzles 210 inject the first liquid content S1 stored in a storage tank (not shown) to the silicon plate 20.

In this instance, when the first liquid content S1 is injected to the silicon plate 20 by the injection nozzles 210, the first liquid content S1 is injected along the circumference of the core 30 seated on the silicon plate 20. After the first content S1 is injected to the circumference of the core 30, the filling step S210 of injecting the first liquid content S1 between the inner surface of the wall body 14 of the separable contents plate 10, which is seated on the silicon plate 20, and the outer surface of the core 30 is carried out.

After the filling step S210 of injecting the first liquid content S1 between the inner surface of the wall body 14 and the outer surface of the core 30 by the first injector 200, as shown in FIG. 12, the silicon plate 20 is conveyed to the first cooling device 300 by the transfer conveyer 100.

The first cooling device 300 cools the first liquid content S1, which fills between the inner surface of the wall body 14 and the outer surface of the core 30, to rapidly solidify the first liquid content S1. The first cooling device 300 is in the form of a tunnel having hot and cold semiconductors mounted in both sides and the upper side thereof, so that the first cooling device 300 reduces temperature of the first liquid content S1 filling the silicon plate 20 while the silicon plate 20 passes through the first cooling device 300, and hence, the first content S1 is rapidly coagulated and solidified in the silicon plate 20 through the first cooling step S220.

As described above, the silicon plate 20 in which the first content S1 is solidified through the first cooling step S220 is conveyed to the core separator 400 by the transfer conveyer 100, and then, the core separating step S230 of separating the core 30 from the silicon plate 20 is carried out.

The core separating step S230 is to separate the core 30 from the silicon plate 20 in which the first content S1 is solidified. When the silicon plate 20 in which the first content S1 is solidified is located under the core separator 400, the core 30 seated on the silicon plate 20 is separated, and the separated core 30 is supplied to the core seating step S130 of seating the core 30 on the silicon plate 20 out of the mold preparing step S100. The core seating step S130 will be described referring to FIGS. 12 to 15.

FIGS. 12 to 15 are a perspective view and a side sectional view showing the first cooling device for solidifying the first content injected to the silicon plate in the first filing step and the core separator for separating the core from the silicon plate, where the first content is solidified, and operational states of the first cooling device and the core separator.

Referring to the drawings, the core separator 400 in the core separating step S230 includes: an elevation unit 410 mounted above the upper portion of the transfer conveyer 100 conveying the silicon plate 20, in which the first content S1 is solidified, for providing a vertical movement and a horizontal movement; a receiving unit 420 mounted under the lower end of the elevation unit 410 for receiving the core 30 by a magnetic force as getting closer to the upper portion of the core 30; and a return conveyer 430 adapted for supplying the core separated from the silicon plate 20 to the core seating step S130 of the mold preparing step S100.

Additionally, the elevation unit 410 of the core separator 400 drops the receiving unit 420, which is located at a predetermined height, above the core 30 seated on the silicon plate 20, in which the first content S1 is solidified, to thereby make the receiving unit 420 get closer to the core 30.

When the receiving unit 420 gets closer to the core 30 by the elevation unit 410, the core 30 made of metal is stuck to an electromagnet 422 by a magnetic force generated from the electromagnet 422 mounted on the receiving unit 420.

As described above, when the core 30 is stuck to the electromagnet 422 by the magnetic force generated from the electromagnet 422 mounted on the receiving unit 420, the elevation unit 420 lifts up the receiving unit 420 to its original height to completely separate the core 30 from the silicon plate 20. After that, the elevation unit 420 moves the receiving unit 420 in a horizontal direction, above the return conveyer 430, and then, the receiving unit 420 is moved above the return conveyer 430 by the elevation unit 420.

Moreover, when the receiving unit 420 having the core 30 moves above the return conveyer 430, it interrupts the magnetic force generated from the electromagnet 422 mounted on the receiving unit 420, the core 30 separated from the silicon plate 20 is loaded on the return conveyer 430, and then, the return conveyer 430 supplies the separated core 30 to the core seating step S130 of the mold preparing step S100.

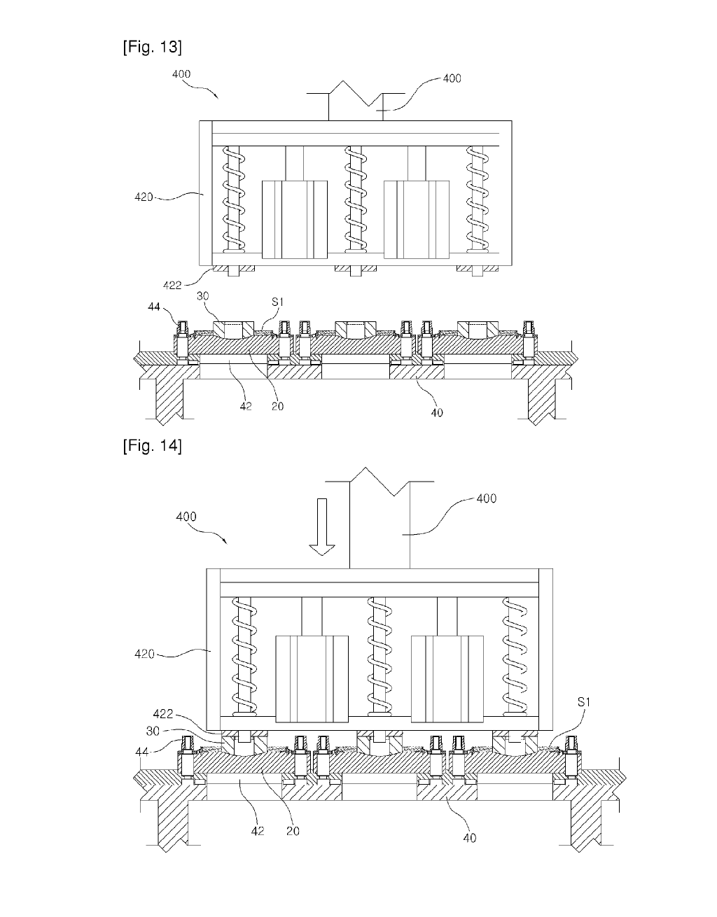

As described above, when the core 30 is separated from the silicon plate 20, in which the first content S1 is solidified, the silicon plate 20 is moved to the second filling step S300 by the transfer conveyer 100. It will be described referring to FIGS. 13 and 14.

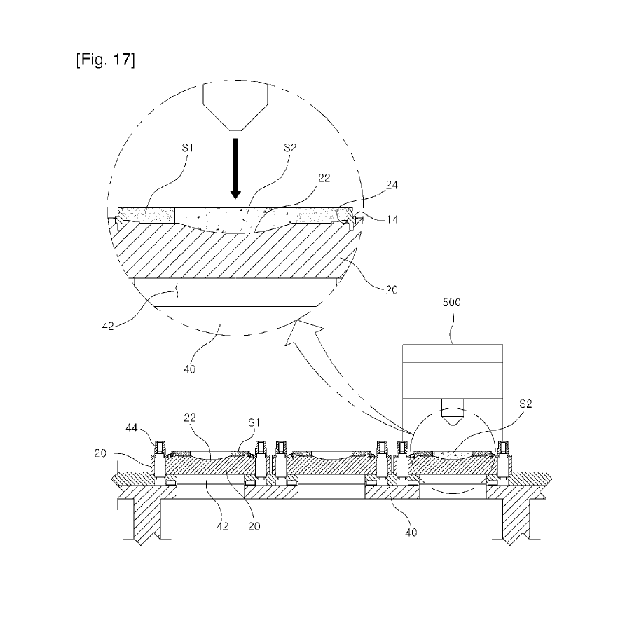

FIGS. 16 and 17 are a perspective view and a side sectional view showing the second injector for injecting the second liquid content to a portion where the core is separated from the silicon plate after the first filling step.

Referring to the drawings, the second filling step S300 includes: a filling step S310 of injecting the second liquid content S2, which has a color different from that of the first content S1, to a portion where the core 30 is separated from the silicon plate in which the first content S1 is solidified; and a second cooling step S320 of solidifying the second content S2 filling the silicon plate 20.

In order to carry out the second filling step S300, the silicon plate 20 from which the core 30 is separated moves to the second injector 500 for injecting the second liquid content S2 to the silicon plate 20 and the second cooling device 600 for solidifying the injected second content S2 in order.

Moreover, the silicon plate 20 from which the core 30 is separated through the first filling step S200 is located under the second injector 500 for injecting the second liquid content S2 to the portion where the core 30 is separated. In this instance, the second liquid content S2 injected to the silicon plate 20 by the second injector 500 has the color different from that of the first content S1 injected in the first filling step S200.

As described above, the second liquid content S2 is injected to the portion where the core 30 is separated from the silicon plate 20, and then, the filling step S310 of injecting the second liquid content S2 to form a pattern more embossed or engraved than the pattern formed by the first content S1 while the second content S2 fills the pattern carved in relief on the inner bottom surface 22 of the silicon plate 20 is carried out.

The silicon plate 20 passing the step S310 of injecting the second liquid content S2 to the silicon plate 20 by the second injector 500 is conveyed to the second cooling device 600 by the transfer conveyer 100.

The second cooling device 600 has a structure similar to that of the first cooling device 300 described in the first filling step S200, but the silicon plate 20 spends more time in the second cooling device 600 than in the first cooling device 300 to completely solidify the first content S1 and the second content S2 filling the silicon plate 20, so that temperatures of the first content S1 and the second content S2 filling the silicon plate 20 are reduced.

For this, the second cooling device 600 may have a size larger than the first cooling device 300 or the conveying speed of the transfer conveyer 100, which conveys the silicon plate 20, becomes slower than the transfer conveyer 100 mounted on the first cooling device 300.

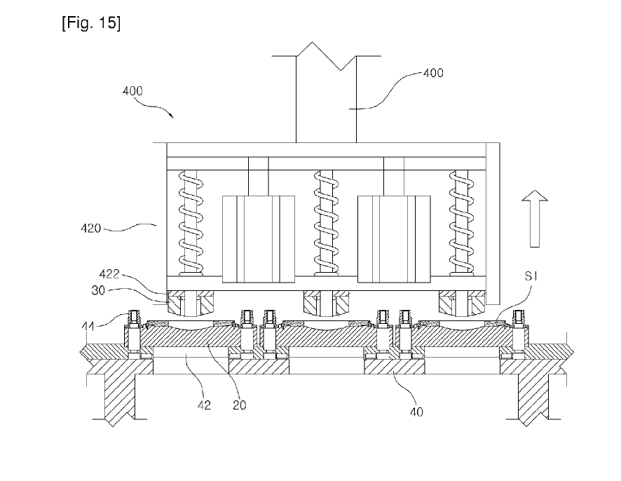

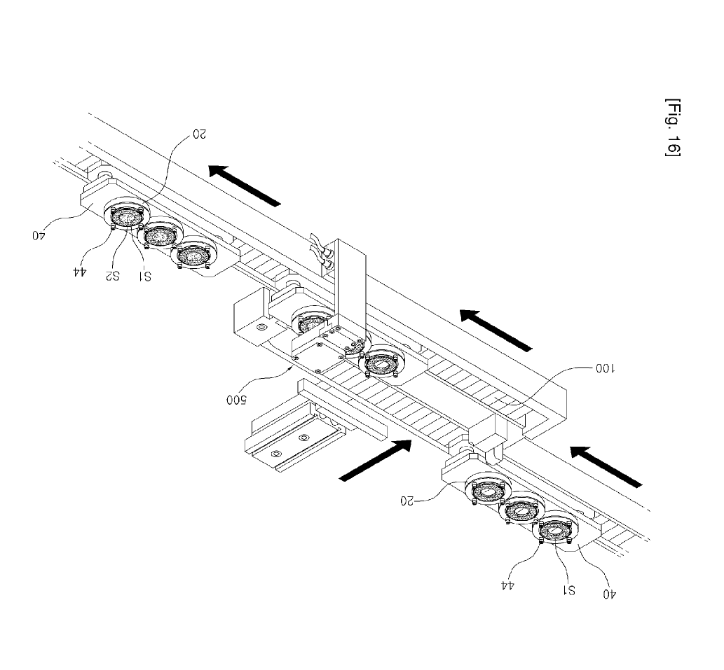

As described above, the silicon plate 20 in which the first content S1 and the second content S2 are solidified through the second cooling step S320 is conveyed to the extractor 700 by the transfer conveyer 100. The separable contents plate 10 is formed by joining the bottom body 12 to the wall body 14 seated on the silicon plate 20, and then, the silicon plate 20 is moved to the contents plate separating step S400 of extracting the separable contents plate 10 and the first content S1 and the second content S2 from the silicon plate 20. Referring to FIGS. 15 to 17, the contents plate separating step S400 will be described.

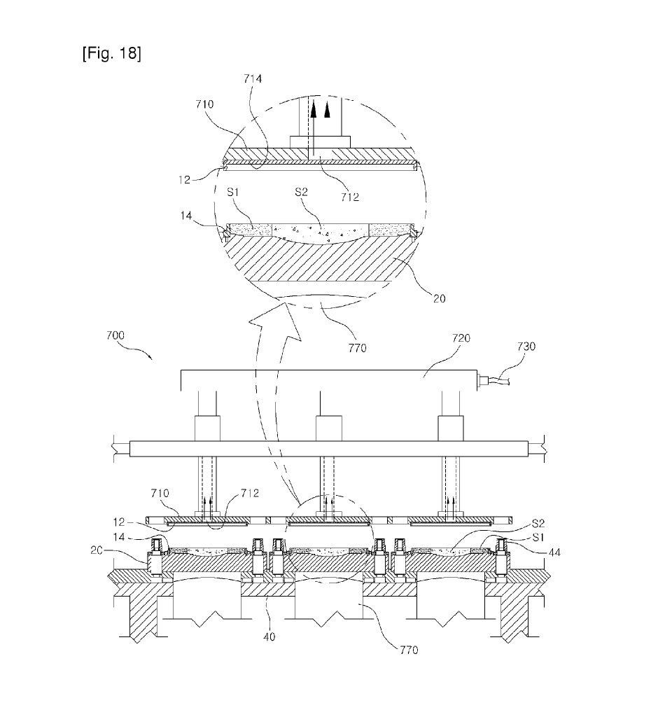

FIGS. 18 to 20 are side sectional views showing a process of forming the separable contents plate by joining the bottom body to the wall body, which is seated on the upper surface of the silicon plate and separating the contents plate from the silicon plate after the second filling step.

Referring to the drawings, in the contents plate separating step S400, the first content S1 and the second content S2 solidified in the silicon plate 20 and the separable contents plate 10, which is formed by joining the bottom body 12 to the wall body 14 and contains the first content S1 and the second content S2, are separated from the silicon plate 20. When the silicon plate 20 is located under the extractor 700, the separable contents plate 10 is formed by the wall body 14 and the bottom body 12 joined with each other, and in this state, the separable contents plate 10 together with the first content S1 and the second content S2 is separated from the silicon plate 20.

The contents plate separating step S400 includes: an arranging step S410 of locating the bottom body 12 above the wall body 14 seated on the silicon plate 20; an assembling step S420 of joining the bottom body 12 to the wall body 14; and a separating step S430 of separating the separable contents plate 10 from the silicon plate 20.

In the arranging step S410, the silicon plate 20, which is filled with the first content S1 and the second content S2 solidified through the second filling step S300, is located under the extractor 700 by the transfer conveyer 100, and especially, the silicon plate 20 is moved to be located directly under the bottom body 12 previously prepared in the extractor 700.

As described above, when the wall body 14 seated on the silicon plate 20 is located directly under the bottom body 12 prepared in the extractor 700, the assembling step S420 of forming the separable contents plate 10 by joining the bottom body 12 to the wall body 14 is carried out. After that, the separating step S430 of separating the separable contents plate 10 and the first content S1 and the second content S2, which are solidified, from the silicon plate 20 is carried out.

Furthermore, the extractor 700 is mounted on the transfer conveyer 100 conveying the silicon plate 20, which passed the second cooling device 600, and includes: an absorbing plate 710 having a suction hole for absorbing the bottom body 12; a conveying unit 720 for conveying the absorbing plate 710 above the wall body 14 seated on the silicon plate 20 from the place where the bottom body 12 is prepared; and an air-inhaling unit 730 for inhaling the outside air through the suction hole 712 formed in the absorbing plate 710.

The absorbing plate 710 is in contact with the bottom surface of the bottom body 12, namely, a flat surface of the outer face, which is in contact with the solidified first content S1 and second content S2, and in the above state, absorbs the outside air around the bottom body 12 through the suction hole 712 formed in the absorbing plate 710, so that the bottom body 12 is stuck to the absorbing plate 710.

Particularly, when the bottom body 12 is absorbed to the absorbing plate 710 in a vacuum condition, in order to prevent that the bottom body 12 is deviated from a correct position of the absorbing plate 710 or is inclinedly stuck to the absorbing plate 710, the absorbing plate 710 has a receiving groove 714, on which the bottom body 12 is seated.

Additionally, the receiving groove 714 has a suction hole 712 formed at the center thereof for inhaling the outside air, and the suction hole 712 is connected with the air-inhaling unit 730 via a flow channel, so that the bottom body 12 can be absorbed to the absorbing plate 710 by the suction hole 712 inhaling the air around the bottom body 12 when the bottom plate 12 becomes closer to the lower portion of the absorbing plate 710.

The absorbing plate 710 moves above the wall body 14 seated on the silicon plate 20 from the place where the bottom body 12 is prepared and lowers toward the wall body 14, and then, is mounted on the conveying unit 720, which joins the bottom body 12 to the wall body 14. The conveying unit 720 has a structure similar to the structure of the elevation unit 410 of the core separator 400 used in the core separating step S230, or joins the bottom body 12 to the wall body 14 seated on the silicon plate 20 by moving the bottom body 12 above the ball body 14 using the conveying robot (not shown) moving and rotating about three axes of an X-axis, an Y-axis, and a Z-axis.

According to the extractor 700 having the above structure, the conveying unit 720 moves the absorbing plate 710 to the place where the bottom body 12 is prepared, and then, the air-inhaling unit 730 inhales the outside air through the suction hole 712, so that the bottom body 12 is absorbed to the absorbing plate 710.

After that, the arranging step S410 of locating the absorbing plate 710, to which the bottom body 12 is absorbed, directly above the wall body 14 seated on the silicon plate 20 by the conveying unit 720 is carried out, and then, the assembling step S420 of lowering the absorbing plate 710 to join the bottom body 12 to the wall body 14 is carried out.

In the meantime, as shown in FIGS. 4 to 6, in the case that the bottom body 12 and the wall body 14 respectively have the spiral threads 12b and 14b or the joining protrusion 12d and the joining hole 14d in order to make the joining of the bottom body 12 and the wall body 14 stronger, when the assembling step S420 is carried out, the absorbing plate 710 for absorbing the bottom body 12 is rotatably formed on the extractor, and hence, the absorbing plate 710 can assemble the bottom body 12 to the wall body 14 rotating the bottom body 12.

In addition, a driving motor (not shown) is mounted on the absorbing plate 710, and the arranging step S410 of locating the absorbing plate 710 directly above the wall body 14 seated on the silicon plate 20 in the state where the bottom body 12 is absorbed to the absorbing plate 710. When the bottom body 12 is assembled to the wall body 14, the absorbing plate 710 lowers toward the wall body 14 to contact the bottom body 12 and the wall body 14 with each other, and then, rotates in such a fashion that the spiral threads 12b and 14b of the bottom body 12 and the wall body 14 are screw-coupled with each other or the joining protrusion 12d and the joining hole 14d of the bottom body 12 and the wall body 14 are firmly coupled with each other.

As described above, when the separable contents plate 10 is formed by the joining of the bottom body 12 and the wall body 14, in the state where the load 770 is inserted into the through hole 42 formed at a portion of the conveying jig 40, the load 770 upwardly pushes the bottom surface of the silicon plate 20, so that there occurs a fine gap between the inner bottom surface 22 of the silicon plate 20 and the solidified first and second contents S1 and S2.

When the fine gap between the inner bottom surface 22 of the silicon plate 20 and the solidified first and second contents S1 and S2 is formed, the separable contents plate 10 containing the solidified first and second contents S1 and S2 can be easily separated from the silicon plate 20.

When the separable contents plate 10 containing the solidified first and second contents S1 and S2 is separated from the silicon plate 20, the conveying unit 720 rotates the absorbing plate 710 in such a way as to be upside down, so that the pattern formed on the second content S2 faces upward, and then, the separating step S430 of separating the separable contents plate 10 from the absorbing plate 710 is carried out.

After the separating step S430, the separable contents plate 10 containing the first content and the second content is conveyed to the next process to put the separable contents plate 10 in a cosmetic container (not shown).

As described above, the separable contents plate consisting of the wall body and the bottom body and the method for molding cosmetics by engraving or embossing the pattern on the surface of the multi-colored solid foundation product using the separable contents plate are differentiated among other cosmetic products and can adapt to consumers' tastes to thereby increase a sales volume of the cosmetic product because the pattern is formed on the surface of the solid foundation product and the pattern is engraved or embossed from the surface of the cosmetic product by colors when the cosmetic contents with different colors are respectively put in the contents plate.

Moreover, the present invention can increase productivity and reduce an error rate of products to thereby reduce a manufacturing price of products because it allows a rapid mass-production when the cosmetic product with the multi-colored pattern is molded in such a fashion that a single-color cosmetic content is engraved or embossed on the surface of the product in the form of the pattern by colors.

While the invention has been described with reference to particular matters, limited embodiments and drawings, it will be understood by those skilled in the art that the invention is not limited to the particular embodiments disclosed since the embodiments are disclosed in the present invention for better understanding of the present invention, but various changes may be made and equivalents may be substituted without departing from the scope of the invention.

1. A separable contents plate comprising:
a bottom body (12) on which solid foundation is put; and
a ring-shaped wall body (14) formed along the outer circumference of the bottom body (12).

2. The separable contents plate according to claim 1, wherein the wall body (14) has a stepped jaw 14a that is formed on a lower end thereof and gets in contact with a projection (12a) formed along the outer circumference of the bottom body (12), and the stepped jaw (14a) and the projection (12a) are assembled through a concavo-convex joint.

3. The separable contents plate according to claim 1, wherein the bottom body (12) getting in contact with the solid foundation has a tread pattern (12c) formed on the inner surface thereof.

4. The separable contents plate according to claim 1, wherein the wall body (14) has receiving indentations (14c) formed on the inner face thereof.

5. The separable contents plate according to claim 1, wherein the bottom body (12) has a spiral thread (12b) formed on the side surface thereof and the wall body (14) has a spiral thread (14b) formed on the inner surface of the lower end thereof, so that the wall body (14) and the bottom body (12) are screw-coupled with each other.

6. The separable contents plate according to claim 1, wherein the wall body (14) has a joining hole (14d) downwardly opened and bent from the inner surface of the lower end thereof and the bottom body (12) has a joining protrusion (12d) formed on the side surface thereof and inserted and joined to the joining hole (14d).

7. A method for molding cosmetics using a separable contents plate (10) that is manufactured by joining a bottom body (12), on which solid foundation is put, and a ring-shaped wall body (14), which is formed along the outer circumference of the bottom body (12), with each other, the cosmetics molding method comprising:
a mold preparing step (S100) of seating the wall body (14) on the upper face of a silicon plate (20), which has a pattern graved in relief on an inner bottom surface (22) thereof, and seating a core (30), which has a pattern formed on the bottom surface in correspondence to the pattern of the inner bottom surface (22) of the silicon plate (20), on the silicon plate (20);
a first filling step (S200) of injecting a liquid content to the silicon plate (20), solidifying the injected content, and separating the core (30) from the silicon plate (20);
a second filling step (S300) of injecting another liquid content, which has a color different from that of the first filling step (S200), to a portion where the core (30) is separated from the silicon plate (20) after the core (30) is separated from the silicon plate (20) in the first filling step (S200); and
a contents plate separating step (S400) of forming the separable contents plate (10) by joining the bottom body (12) to the wall body (14) when the content injected in the second filling step (S300) is solidified, and separating the separable contents plate (10) and the solidified content from the silicon plate (20).

8. The cosmetics molding method according to claim 4, wherein the mold preparing step (S100) comprises:
a loading step (S110) of fixing the silicon plate (20) having the pattern, which is carved in relief on the inner bottom surface (22), at a conveyance jig (40) and loading the conveyance jig (40) on the transfer conveyer (100);
a wall body seating step (S120) of seating the wall body (14) on the silicon plate (20) loaded on the transfer conveyer (100); and
a core seating step (S130) of seating the core (30), which has the pattern formed on the bottom surface thereof in correspondence to the pattern of the inner bottom surface (22) of the silicon plate (20), on the silicon plate (20).

9. The cosmetics molding method according to claim 4, wherein the first filling step (S200) comprises:
a filling step (S210) of injecting a first liquid content (S1) to the silicon plate (20);
a first cooling step (S220) of solidifying the first content (S1) filling the silicon plate (20); and
a core separating step (S230) of separating the core (30) from the first content (S1) solidified after the first cooling step (S220).

10. The cosmetics molding method according to claim 6, wherein the core (30) separated from the silicon plate (20) in the core separating step (S230) is returned to the mold preparing step (S100).

11. The cosmetics molding method according to claim 4, wherein the second filling step (S300) comprises:
a filling step (S310) of injecting a second liquid content (S2), which has a color different from that of the first content (S1), to a portion where the core (30) is separated from the silicon plate (20); and
a second cooling step (S320) of solidifying the second content (S2) filling the silicon plate (20).

12. The cosmetics molding method according to claim 4, wherein the contents plate separating step (S400) comprises:
an arranging step (S410) of locating the bottom body (12) above the wall body (14) seated on the silicon plate (20);
an assembling step (S420) of joining the bottom body (12) to the wall body (14); and
a separating step (S430) of separating the separable contents plate (10) formed in the assembling step (S420) from the silicon plate (20).

13. The cosmetics molding method according to claim 9, wherein in the separating step (S430), when the separable contents plate (10) is formed by the joining of the bottom body (12) and the wall body (14), a load (770) upwardly pushes the bottom surface of the silicon plate (20), so that there occurs a gap between the inner bottom surface (22) of the silicon plate (20) and the solidified first and second contents (S1, S2).
